(19) United States
(12) Patent Application Publication
(10) Pub. No.: US 2021/0056554 A1
(43) Pub. Date: Feb. 25, 2021

(54) AUTHENTICATING CUSTOMERS BASED ON CONNECTIONS AND LOCATION DATA

(71) Applicant: Wells Fargo Bank, N.A., Charlotte, NC (US)

(72) Inventors: Sri Saravana Muthu, Duluth, MN (US); Dominik Vltavsky, Belmont, CA (US); Melody Kao, San Francisco, CA (US)

(73) Assignee: Wells Fargo Bank, N.A., Charlotte, NC (US)

(21) Appl. No.: 14/847,366

(22) Filed: Sep. 8, 2015

(51) Int. Cl. G06Q 20/40; G06Q 50/00

(52) U.S. Cl. CPC G06Q 20/40145; G06Q 50/01; G06Q 20/401

(57) ABSTRACT

Systems and methods of authenticating customers of a financial institution are provided. A customer, involved in a financial transaction may be authenticated before consummation of a financial transaction. Authentication includes the system and method verifying the customer's identity and identifying the customer as a trusted customer. Authentication further includes aspects for determining the customer is co-located with the financial institution.

### BACKGROUND

Authenticating customers for financial uses is too susceptible to fraud and/or is a cumbersome process. Oftentimes it is reliant on just a password that must be memorized by the customer and stored by the financial institution. Identity thieves are able to obtain the password and use them knowing the financial institution do not have another way to confirm a customer's identity. Further, trusting customers can be a cumbersome process for the financial institution. The financial institution may rely on costly background checks or the like. Such methods are inefficient and unreliable.

### BRIEF DESCRIPTION

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods of authenticating customers of a financial institution. A customer, e.g. a general banking customer or and officer, e.g., CEO (Chief Executive Officer) of a company involved in a financial transaction, may be authenticated, e.g. identity verified and known as a trusted customer, before consummation of a financial transaction.

In aspects of the innovation, a person to person concept is contemplated where a financial institution brokers a relationship with the customer, e.g. a client, or a friend to friend relationship. Multiple factors result in seamless authentication without use of a password. The factors can be grouped in, for example, three groupings: customer identity (e.g. as identified through social media), customer device, and geographic location. For example, a financial institution is able to identify the customer present in the room with his broker affiliated or associated with the financial institution. The customer could be authenticated based on identity and geographic location. The broker can be a distinct trusted broker or part of grouping of trusted persons, or other trusted entity, who is bound by a mobile device and/or close to an ATM/branch/store. Further identification aspects can include physical cameras and image recognition along with device location. It is to be understood that other biometric or contextual factors can be employed in alternative aspects. The amount of information that could be collected in the different identifying information categories for the one transaction or type of activity the customer is trying to perform can eliminate or otherwise alleviate a requirement of password or additional authentication requirements. Authentication can be based on past behavior, based on a combination of social media e.g. Facebook, LinkedIn, E-mail, and/or image recognition (e.g., biometrics) or the like.

In one exemplary aspect of the innovation, a method for authenticating a customer of a financial institution is provided. The method includes receiving an authentication request to authenticate a customer and receiving connections information relating to a customer. The method can further include generating a connections graph of the connections between the customer and a plurality of parties; identifying the customer; and authenticating the customer based at least in part on the connections graph and the identification.

In another example embodiment of the innovation, an authentication device for authenticating a customer for a financial institution is provided. The authentication device includes a connections component that receives connections and connections information relating to a customer. The authentication device further includes a graphing component that generates a connections graph of connections between the customer and a plurality of parties or entities. The authentication device includes a verification component that identifies the customer; and an authorization component that authenticates the customer based at least in part on the connections graph.

In yet another example embodiment, a computer readable medium having instructions to control one or more processors is provided. The processors are configured to receive an authentication request to authenticate a customer; identify a relationship between the customer and a broker employed by a financial institution using a first mobile device that is associated with the customer; determine the first mobile device is located near a second mobile device that is associated with a broker employed by a financial institution; and authenticate the customer based on the identified relationship and the determined nearness of the first mobile device to the second mobile device. The processors identify the relationship between the customer and the financial institution by being further configured to receive connections information relating to the customer; generate a connections graph of the connections information between the customer and a plurality of parties; and identify the broker as one party of the plurality of parties. The processors are further configured to determine the type of relationship between the customer and the broker; and identify the relationship as a trusted relationship. While a customer and broker are specifically used in the scenario described herein, it is to be understood and appreciated that most any two parties or entities can be used without departing from the spirit and/or scope of the innovation described herein.

In aspects, the subject innovation provides substantial benefits in terms of authentication and transactional security. One advantage resides in a more secure knowledge of the identity of a customer. Another advantage resides in the lack of need for a password to authenticate a customer.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings. It will be appreciated that elements, structures, etc. of the drawings are not necessarily drawn to scale. Accordingly, the dimensions of the same may be arbitrarily increased or reduced for clarity of discussion, for example.

FIG. 1 illustrates an example input-output diagram for authenticating a customer using an authentication device.

FIG. 2 illustrates an example component diagram of an authentication device.

FIG. 3 illustrates an example component diagram of a connections graphing component.

FIG. 4 illustrates an example component diagram of a location component.

FIG. 5 illustrates an example component diagram of a verification component.

FIG. 6 illustrates an example decision flowchart to authenticate a customer.

FIG. 7 illustrates a computer-readable medium or computer-readable device comprising processor-executable instructions configured to embody one or more of the provisions set forth herein, according to some embodiments.

FIG. 8 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

While certain ways of displaying information to users are shown and described with respect to certain figures as screenshots, those skilled in the relevant art will recognize that various other alternatives can be employed. The terms “screen,” “web page,” “screenshot,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

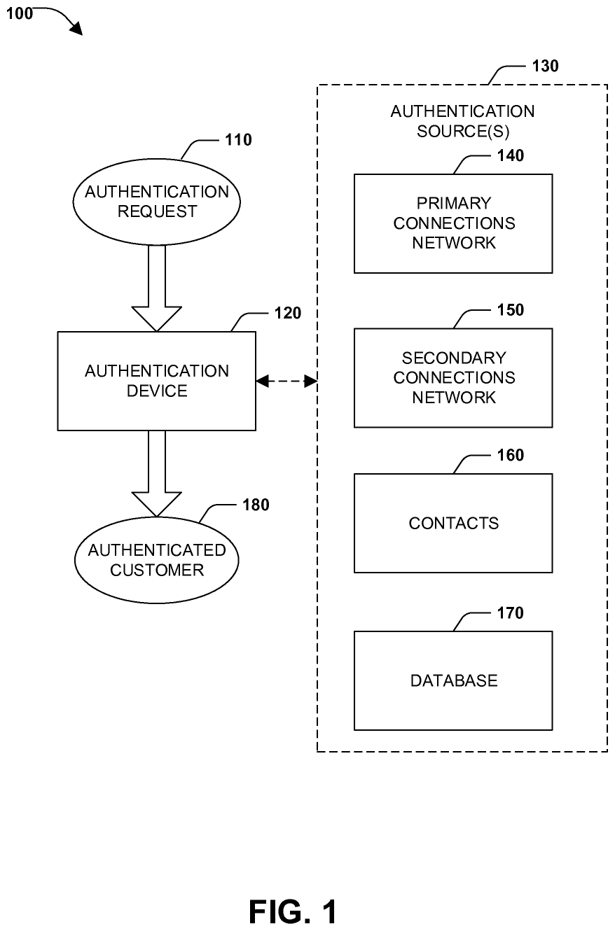

With reference to FIG. 1, an example input/output diagram 100 for authenticating a customer using an authentication device is depicted. An authentication request 110 to authenticate a customer is received by an authentication device 120. The authentication device 120 interacts with authenticating sources 130. The authenticating sources 130 are sources that have information relating to the customer that facilitate in identifying the customer as the customer and determining a trust level associated with the customer.

The authenticating or authentication sources 130 can include a primary connections network 140, a secondary connections network 150, contacts 160, and/or a database 170. While specific factors are shown and described herein to effect authentication, it is to be appreciated that additional and/or a subset of those shown can be employed in alternate embodiments and considered within the scope of this specification and claims appended hereto. In the example of FIG. 1, the primary connections network 140 may be a connections network or networking website showing direct connections between the customer and other people or entities. For example, the primary connections network 140 can show a customer is connected to a financial institution or the financial institution's broker and/or employee via the network. The secondary connections network 150 maybe a connections network or networking website that shows indirect connections between the customer and other people or entities. For example, a customer can be connected to another person whom is connected directly to the financial institution. Another example includes belonging to a group that is trusted by the financial institution. The contacts 160 can be a list and/or database of direct contact information of people or entities associated with the customer. For example, the contacts 160 can be an address book associated with an email address of the customer. The database 160 can be a database listing and/or file having the connections associated with the customer. For instance, the database 160 can be a digital rolodex, mobile device contacts and/or the like. The authentication device 120 uses the authenticating sources 130 to authenticate the customer 180 so that a financial transaction may be consummated.

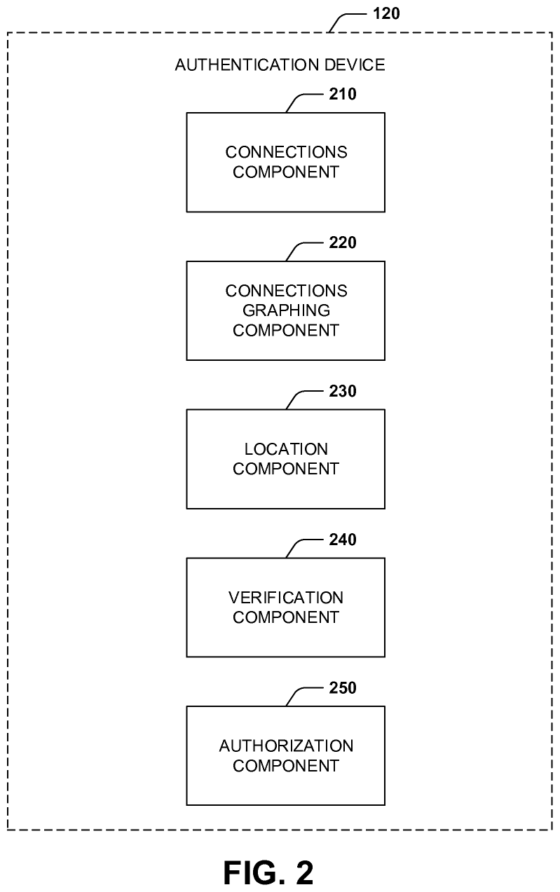

With reference to FIG. 2, an example component diagram of the authentication device 120 is depicted. In the example illustrate, the authentication device 120 includes a connections component 210, a connections graphing component 220, a location component 230, a verification component 240, and an authorization component 250. The connections component 210 of the authentication device 120 accesses the authenticating sources 130 to receive connections information relating to the customer. The connections component 210 can store the connections information in a database or storage medium (e.g., cloud, network, local) (not shown) on the authenticating device 120 for analysis. It is to be understood that storage or retention of data can be local or remote to the authentication device 120 and otherwise in operable communication therewith for storage, retrieval, etc.

The connections graphing component 220 accesses the connections information received by the connections component 210. The connections graphing component 220 generates a connections graph based on the connections information. The connections graph identifies relationships between the customer and a connection. Other components shown in FIG. 2 are described in connection with the figures discussed infra.

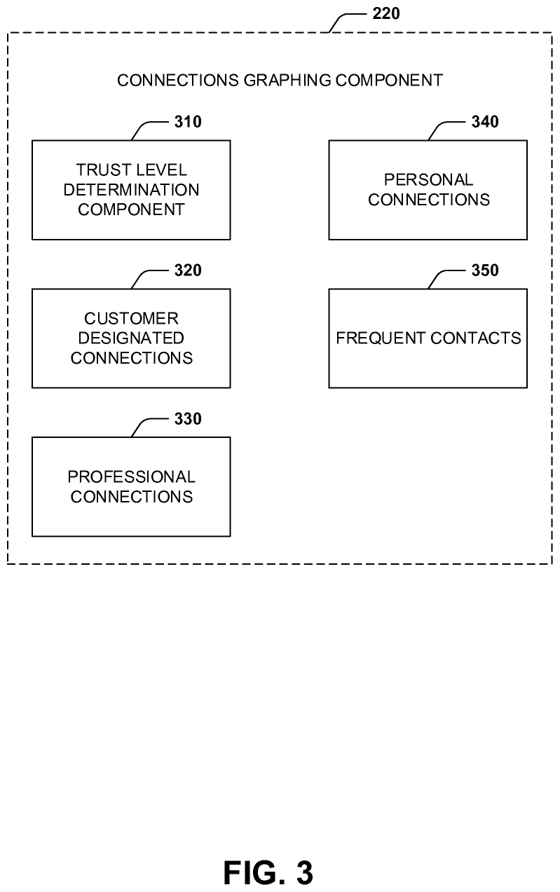

With reference to FIG. 3, an example component diagram of the connections graphing component 220 is depicted. The connections graphing component 220 includes a trust level determination component 310. The trust level determination component 310 analyzes whether the customer can be a trusted for the financial transaction. The trust level determination component 310 organizes the connections, e.g., into categories. The categories can be customer designated connections 320, professional connections 330, personal connections 340, frequent contacts 350, and/or the like. Different weights may be associated with each type of connection such that different connections are weighted more in favor determining a level of trust high enough to be used for the financial transaction. For example, a professional connection 330 may be weighted more than a customer designated connection 320.

In one embodiment, the trust level determination component 310 evaluates connections in each type of connection. For example, the trust level determination component 310 can identify the customer as being connected on the primary connections network 140 to the financial institution or a broker of the financial institution. As another example, the trust level determination component 310 can identify the customer as being connected on the secondary connections network 150 to another customer who is directly connected to the financial institution via the primary connections network 140. In one embodiment, each type of connection can be associated with a level of trust. In one embodiment, the evaluated connection is taken alone to determine the level of trust associated with the customer. In another embodiment, multiple connections can be aggregated to determine a single level of trust. In another embodiment, a customer that is connected to two trusted secondary connections is trusted equally as a customer that is connected to one primary connection.

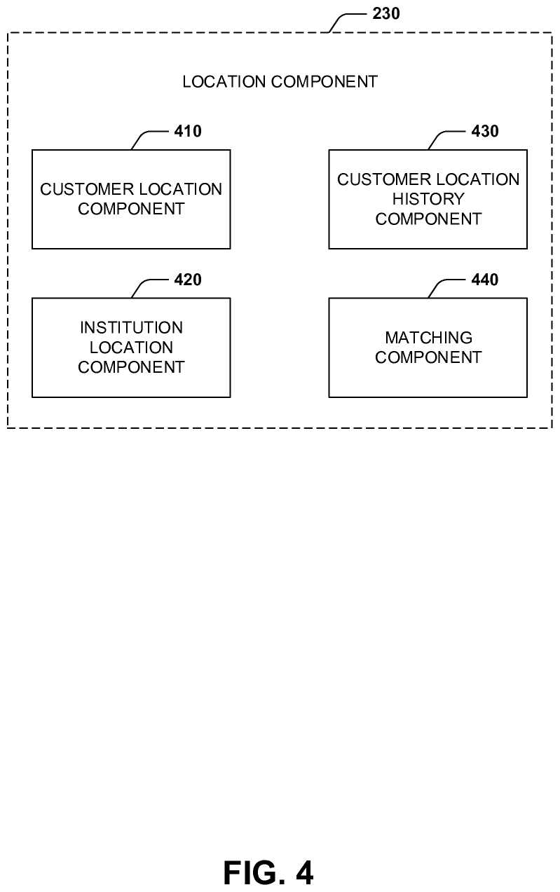

With reference to FIG. 4 and continuing reference to FIG. 2, an example component diagram of a location component 230 is depicted. The location component 230 includes a customer location component 410, an institution location component 420, a customer history location component 430, and a matching component 440. The customer location component 410 retrieves the present location of the customer. The location can be based up most any factors including, but not limited to, global positioning system (GPS) coordinates, Wi-Fi, triangulation, etc. In another embodiment, the customer location component 410 can retrieve the customer location via the primary connections network. For example, the customer can be “checked in” at a location via a connections network, which can be used as the location of the customer. In one embodiment, the GPS coordinates and/or the location via the connections network can be used in tandem to verify one another. In one embodiment, the GPS coordinates are received from a mobile device of the customer.

The institution location component 420 retrieves and/or stores the location of the financial institution and/or a broker or agent of the financial institution. The location can be stored locations for automated teller machines (ATM), financial institution branch locations, financial institution office locations, and/or the like. The location can be stored as GPS coordinates or the like. In one embodiment, the location can be that of a broker or agent of the financial institution. In this example, the location can be based up most any factors including, but not limited to, global positioning system (GPS) coordinates, Wi-Fi, triangulation, etc. In another embodiment, the institution location component 410 can retrieve the broker's location via the primary connections network. For example, the broker can be “checked in” at a location via a connections network, which can be used as the location of the broker. In one embodiment, the GPS coordinates and/or the location via the connections network can be used in tandem to verify one another. In one embodiment, the GPS coordinates are received from a mobile device of the broker.

The customer location history component 430 retrieves and/or stores previous location data of the customer. The previous location data can be stored a predetermined time period. The previous location data 430 can facilitate in verifying the customer identity and fraud protection. For example, the customer location history component 430 can detect and/or determine customer location changes that are not feasible. For example, the customer location history component 430 can detect large changes in the customer location in a relatively small amount of time which can be indicative of fraud.

The matching component 440 determines whether the customer location and the institution location are co-located, e.g. are within a maximum or threshold distance of one another such that it can be determined they are in the same place and intend to complete a transaction. In one embodiment, the matching component 440 receives the customer location from the customer location component 410 and the institution location from the institution location component 420 as GPS coordinates. The matching component 440 determines the distance between the two locations. The matching component 440 compares the distance between the two locations to a maximum distance. The maximum distance may be a predetermined value. In one embodiment, the maximum distance is specific to an institution branch, institution ATM, and/or the broker of the financial institution.

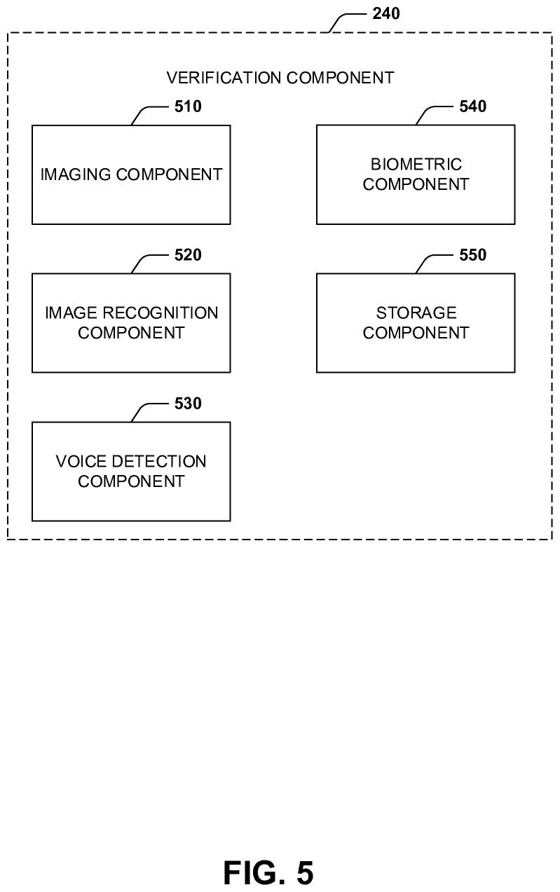

With reference to FIG. 5, and continuing reference to FIG. 2, an example component diagram of the verification component 240 is depicted. The verification component 240 confirms and/or validates the identity of the customer. The verification component 240 facilitates fraud prevention, e.g. identity or device theft. The verification component 240 includes an imaging component 510, an image recognition component 520, a voice detection component 530, a biometric component 540, and a storage component 550. The imaging component 510 can capture imaging data of the customer. The imaging data can be video or still photographs of the customer. In one embodiment, the imaging component 510 is a camera and/or the like. The imaging component 510 captures the imaging data of the customer when the authentication request 110 is generated or at any time or randomly during authentication. In one embodiment, the authenticating device 120 may prompt the customer to take a photograph of themselves, e.g. a “selfie.” In another embodiment, the customer may take a video of themselves to prevent fraud. In yet other embodiments, images can be captured randomly via a mobile device or other image capture device.

The image recognition component 520 receives the imaging data from the imaging component 510. The image recognition component 520 analyzes the imaging data to confirm the customer is the person in the imaging data. The image recognition component 520 can use a known and/or confirmed picture of the customer to compare to the imaging data and confirm the customer's identity. In one embodiment, the known picture can be used from the customer's profile on a connections network, e.g. social media website. The image recognition component 520 can use any known image recognition algorithms.

The voice detection component 530 can confirm the customer's identity using voice detection algorithms. The voice detection component 530 can use a microphone to compare the customer's voice with a known recording of the customer's voice (e.g., voice print). The biometric component 540 can confirm the customer's identity using biometric matching algorithms and comparing the customer's biometric data with known biometric data of the customer. The storage component 550 can store the authentication data for verifying the customer's identity. The storage component 550 can include a database, hard disk drive, cloud storage, and/or the like.

In one embodiment, the authentication device 120 grants the authentication request to authenticate the customer for the financial transaction upon a verification of the customer identity and a determination the customer is co-located with the financial institution. In another embodiment, the authentication device 120 further verifies the customer's identity before granting the request.

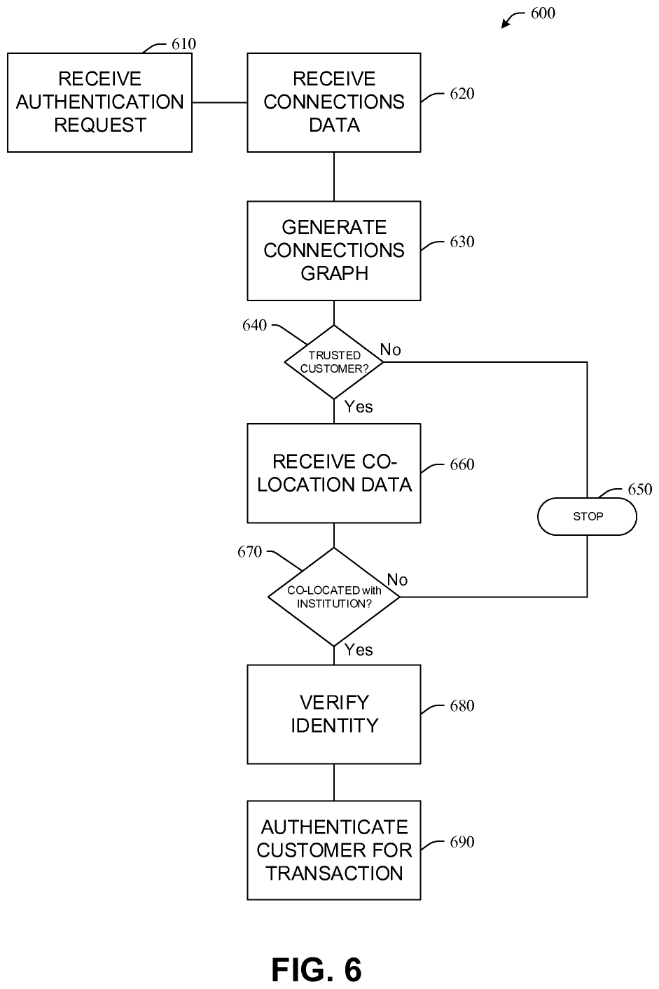

With reference to FIG. 6, an example method 600 is depicted for authenticating a customer of a financial institution. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. It is also appreciated that the method 600 is described in conjunction with a specific example is for explanation purposes.

In aspects, method 600 can begin at 610 by receiving an authentication request. For example, a customer desires to complete a financial transaction using a financial institution. The customer and/or the financial institution may initiate an authentication request to authenticate the customer. In this specific example, the authenticating device is a mobile device of a broker employed by the financial institution. However, it is appreciated that the request may be received by an authentication device such as a computer, a mobile device and/or the like and used by the customer or the financial institution.

At 620, connections data is received. Continuing the example, the authenticating device, e.g. broker's mobile device, accesses the customer's social media profile to analyze the customer's connections, e.g. “friends,” “groups,” friends of friends, or the like. At 630, a connections graph or tree is generated of the customer's connections data to look for trusted connections to facilitate determining the customer can be trusted as part of the financial transaction. In the above example, the authenticating device searches for friends employed by (or in a trusted relationship with) the financial institution or friends that have already been authenticated and/or trusted by the financial institution. The common connections facilitate determining a trust level of the customer. At 640, the determination to trust (or not to trust) the customer is made. If no, the method 600 stops at 650 because the customer cannot be authenticated for the transaction. If yes, the method 600 proceeds.

At 660, location data of the customer is received. In one embodiment, the location data of the financial institution or broker is received. In another embodiment, the location data of the financial institution is already known and/or pre-loaded in a memory or the like. For example, the customer is determined to be a trusted customer through social media connections to the financial institution. The customer's mobile device sends location data of the customer to the authentication device. The authentication device then receives location data of the broker employed by the financial institution and determines the distance between the customer and the broker. At 670, if the determined distance is below a maximum or threshold distance, the customer is determined to be co-located with the broker. If the distance is above the maximum distance, the method 600 stops at 650 because the customer cannot be authenticated for the transaction.

At 680, the customer's identity may be verified. The identity may be verified using a known metric of the customer and an immediate or present metric of the customer. In the example, a customer's image can be captured from their mobile device and then used to compare against a known confirmed photo of the customer to verify the customer's identity. In another embodiment, video data from a surveillance camera in the institution can be used to capture image data of the customer.

At 690, the customer is authenticated for the transaction when the customer is trusted and co-located with the financial institution. In the example, the customer may proceed with the financial transaction without using a memorized password or key. The customer is authenticated by the financial institution by being socially connected with the financial institution and being in the presence of the financial institution.

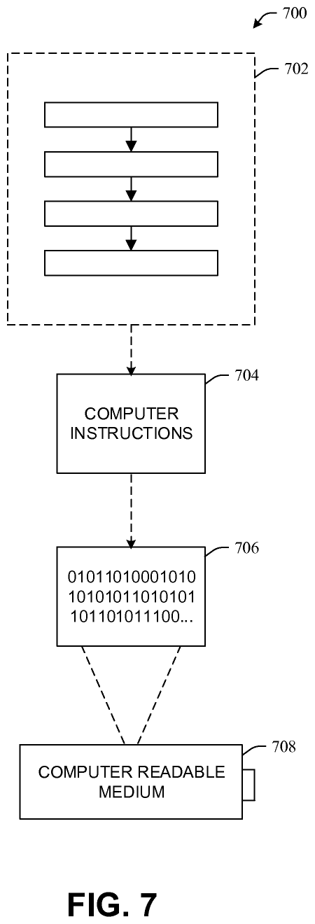

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 7, wherein an implementation 700 comprises a computer-readable medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of computer instructions 704 configured to operate according to one or more of the principles set forth herein. In one such embodiment 700, the processor-executable computer instructions 704 is configured to perform a method 702, such as at least a portion of one or more of the methods described in connection with embodiments disclosed herein. In another embodiment, the processor-executable instructions 704 are configured to implement a system, such as at least a portion of one or more of the systems described in connection with embodiments disclosed herein. Many such computer-readable media can be devised by those of ordinary skill in the art that are configured to operate in accordance with the techniques presented herein.

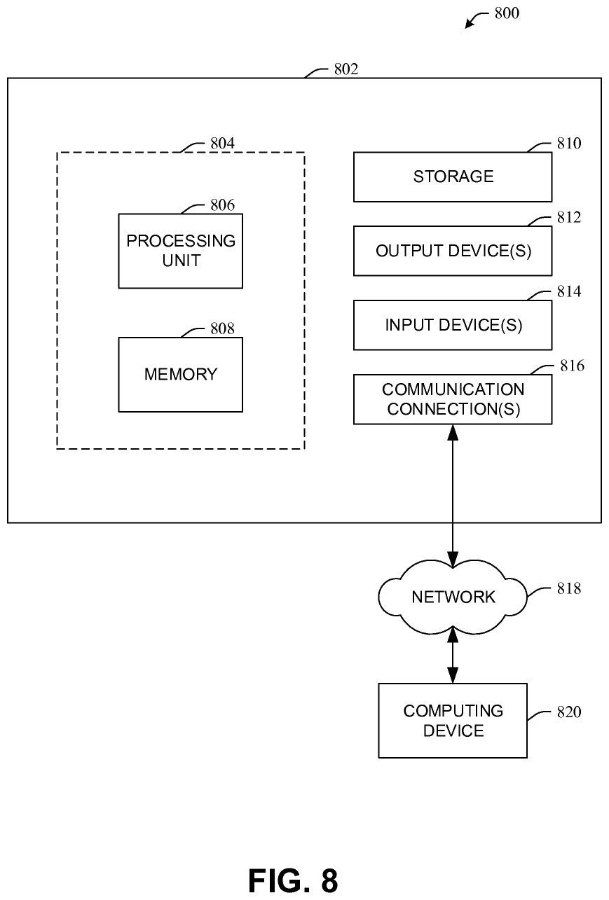

With reference to FIG. 8 and the following discussion provide a description of a suitable computing environment in which embodiments of one or more of the provisions set forth herein can be implemented. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 8 illustrates a system 800 comprising a computing device 802 configured to implement one or more embodiments provided herein. In one configuration, computing device 802 can include at least one processing unit 806 and memory 808. Depending on the exact configuration and type of computing device, memory 808 may be volatile, such as RAM, non-volatile, such as ROM, flash memory, etc., or some combination of the two. This configuration is illustrated in FIG. 8 by dashed line 804.

In these or other embodiments, device 802 can include additional features or functionality. For example, device 802 can also include additional storage such as removable storage or non-removable storage, including, but not limited to, magnetic storage, optical storage, and the like. Such additional storage is illustrated in FIG. 8 by storage 810. In some embodiments, computer readable instructions to implement one or more embodiments provided herein are in storage 810. Storage 810 can also store other computer readable instructions to implement an operating system, an application program, and the like. Computer readable instructions can be accessed in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media can be part of device 802.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 802 can include one or more input devices 814 such as keyboard, mouse, pen, voice input device, touch input device, infrared cameras, video input devices, or any other input device. One or more output devices 812 such as one or more displays, speakers, printers, or any other output device can also be included in device 802. The one or more input devices 814 and/or one or more output devices 812 can be connected to device 802 via a wired connection, wireless connection, or any combination thereof. In some embodiments, one or more input devices or output devices from another computing device can be used as input device(s) 814 or output device(s) 812 for computing device 802. Device 802 can also include one or more communication connections 816 that can facilitate communications with one or more other devices 820 by means of a communications network 818, which can be wired, wireless, or any combination thereof, and can include ad hoc networks, intranets, the Internet, or substantially any other communications network that can allow device 802 to communicate with at least one other computing device 820.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A method for authenticating a customer of a financial institution, using an authentication device associated with the financial institution, the method comprising:
receiving, at an authentication device, an authentication request to authenticate a customer;
receiving, at the authentication device, from authenticating sources, connections information relating to a customer;
generating, at a connections graphing component within the authentication device, a connections graph of the connections information between the customer and a plurality of parties;
identifying, the authentication device, the customer;
authenticating, via an authentication component within the authentication device, the customer based at least in part on the connections graph and the identification, wherein authentication involves at least the customer being socially connected to the financial institution and being in the presence of the financial institution, wherein a customer authenticated by the financial institution by being socially connected with the financial institution and being in the presence of the financial institution may proceed with the financial institution without using a memorized password or key, wherein the authentication request is initiated by the financial institution; and
determining, via a customer location history component within the authentication device, whether changes in customer location over a short period are not feasible, and therefore indicative of fraud.

2. The method of claim 1, wherein connections are at least one of a social networking connection associated with a social network, a contact from a customer mobile device, a customer designated connection, a professional connection, or a frequent customer connection.

3. The method of claim 1, wherein authenticating the customer comprises, at least:
determining a trust level associated with the customer based on the connections graph.

4. The method of claim 1, wherein generating the connections graph further comprises:
determining at least one or more connections as a trusted connection by the financial institution.

5. The method of claim 4, wherein the trusted connection is between the customer and an employee associated with the financial institution.

6. The method of claim 4, wherein the trusted connection is between the customer and a different customer, wherein the different customer has been determined to be a high value customer of the financial institution.

7. The method of claim 1, wherein identifying the customer further comprises:
receiving location data from a customer device; and
determining whether the customer is co-located with the financial institution.

8. The method of claim 7, wherein determining the customer is co-located with the financial institution further comprises:
determining a distance from the location data from the customer device and location data from the financial institution; and
comparing the distance with a predetermined maximum, wherein the customer is co-located with the financial institution if when the distance is less than the predetermined maximum.

9. The method of claim 1, further comprising:
verifying a customer identity using one of facial recognition, voice recognition, or biometric recognition.

10. An authentication device for authenticating a customer for a financial institution, the authentication device implementing components via at least one processor, the components comprising:
a processor that executes computer executable components stored in a memory;
a connections component that receives connections information relating to a customer;
a graphing component that generates a connections graph of connections between the customer and a plurality of parties, wherein the graphing component includes a trust level determination component that analyzes whether a customer can be trusted for a financial transaction, wherein the trust level determination component organizes the connections into categories and weights certain categories more heavily than others in determining a level of trust high enough to be used for a financial transaction, wherein categories include customer designated connections, professional connections, personal connections, and frequent contacts;
a verification component that identifies the customer; and
an authorization component that authenticates the customer based at least in part on the connections graph,
wherein the connections component accesses a primary connections network having connections associated directly with the customer, a secondary connections network having connections associated indirectly with the customer, contacts, or a database, and
wherein a customer that is connected to two secondary connections is trusted as much as a customer connected to one primary connection.

11. (canceled)

12. (canceled)

13. The authentication device of claim 10, wherein the graphing component determines one or more connections as a trusted connection by the financial institution.

14. The authentication device of claim 13, wherein the trusted connection is between the customer and a banker associated with the financial institution.

15. The authentication device of claim 13, wherein the trusted connection is between the customer and a different customer, wherein the different customer has been determined to be a high value customer of the financial institution.

16. The authentication device of claim 13, further comprising:
a location component that determines whether the customer is co-located with a trusted connection from location data from a customer device,
wherein the location component comprises at least a customer location history component, a customer location component, an institution location component, and a matching component, the customer location history component being operative to detect customer location changes that are not feasible, likely indicating fraud.

17. The authentication device of claim 16, wherein the location component determines the customer is co-located with a trusted connection by:
determining a distance from the location data from the customer device and location data from the trusted connection; and
comparing the distance with a predetermined maximum, wherein the customer is co-located with the trusted connection when the distance is less than the predetermined maximum.

18. The authentication device of claim 10, wherein the verification component identifies the customer using one of facial recognition, voice recognition, or biometric recognition.

19. A computer readable medium having instructions to control one or more processors configured to:
receive an authentication request to authenticate a customer;
identify a relationship between the customer and a broker employed by a financial institution using a first mobile device that is associated with the customer;
determine the first mobile device is located near a second mobile device that is associated with a broker employed by a financial institution; and
authenticate the customer based on the identified relationship and the determined nearness of the first mobile device to the second mobile device.

20. The computer readable medium of claim 19, identifying the relationship includes the one or more processors further configured to:
receive connections information relating to the customer;
generate a connections graph of the connections information between the customer and a plurality of parties;
identify the broker as one party of the plurality of parties;
determine the type of relationship between the customer and the broker; and
identify the relationship as a trusted relationship.

21. The method of claim 1, wherein authentication involves searching for contacts of the customer employed by or in a trusted relationship with the financial institution or contacts that have already been authenticated by the financial institution.

22. The authentication device of claim 16, wherein the location component can retrieve customer location via the primary connections network, wherein a customer is checked-in at a location via a wireless network and GPS coordinates and the location determined via the wireless network are used in tandem to verify one another.
